(19) United States
(12) Patent Application Publication
(10) Pub. No.: US 2020/0368802 A1
(43) Pub. Date: Nov. 26, 2020

(54) METHOD FOR MANUFACTURING VEHICULAR SIDE DOOR, DOOR COMPONENT, AND SIDE DOOR

(71) Applicant: Kabushiki Kaisha Kobe Seiko Sho (Kobe Steel, Ltd.), Kobe-shi (JP)

(72) Inventor: Keisuke AKASAKI, Kobe-shi (JP)

(73) Assignee: Kabushiki Kaisha Kobe Seiko Sho (Kobe Steel, Ltd.), Kobe-shi (JP)

(21) Appl. No.: 16/833,835

(22) Filed: Mar. 30, 2020

(30) Foreign Application Priority Data
May 20, 2019 (JP) 2019-094289

(51) Int. Cl. B21D 22/02; B21D 53/88; B60J 5/04

(52) U.S. Cl. CPC B21D 22/022; B60J 5/045; B60J 5/0483; B21D 53/88

(57) ABSTRACT

A method for manufacturing a vehicular side door capable of suppressing occurrence of a residual deformation in a frame of a sash part and a panel member of a door body part in a manufacturing step including a heating step. The method for manufacturing a vehicular side door includes joining each of one end part of a front frame in the vehicle longitudinal direction and one end part of a rear frame to at least one door panel member, heating at least one door panel member, the front frame, and the rear frame joined in the first joining step, and joining the other end part of the front frame and the other end part of the rear frame to each other after the heating step.

### FIELD OF INVENTION

The present invention relates to a method for manufacturing a vehicular side door, a door component, and a side door.

### BACKGROUND OF INVENTION

JP-A No. 2017-077784 discloses a vehicular door structure that aims to suppress the strain generated in a door outer panel in a vehicular door formed using plural materials having different coefficient of thermal expansion. The vehicular door structure includes a door outer panel, a door inner panel, and a frame part, the door inner panel being joined to the door outer panel. The frame part is formed using material having a coefficient of thermal expansion different from that of the door inner panel.

The paragraph 0009 of this JP-A No. 2017-077784 discloses that, since the first joined part and the second joined part arranged in the door inner panel protrude vehicle upward beyond the vehicle upper side end of the door outer panel as seen from the vehicle outer side, expansion or shrinkage of a portion opposing the door outer panel in the door inner panel is suppressed from being restricted by the frame part, which results in that the portion opposing the door outer panel in the door inner panel is allowed to expand or shrink following the door outer panel, and that the strain of the door outer panel accompanying temperature change of the vehicular door can be suppressed.

### SUMMARY OF INVENTION

According to the vehicular door structure described in JP-A No. 2017-077784, since the coefficient of thermal expansion (linear coefficient of expansion) of the inner panel and the coefficient of thermal expansion (linear coefficient of expansion) of the frame part are different from each other, when the vehicular door is heated in the manufacturing step of the vehicular door and is thereafter cooled for example, the inner panel and the frame part expand at rates different from each other, and thereafter shrink. According to the vehicular door structure, a pair of front and rear lower end parts in the continuous one-piece frame part are joined to the front end part and the rear end part of the inner panel. Therefore, one member out of the inner panel and the frame part restrains the other member so as to restrict expansion and shrinkage of the other member. Concretely, when the vehicular door is heated, a member having a smaller value of the linear coefficient of expansion out of the inner panel and the frame part restricts expansion of a member having a larger value of the linear coefficient of expansion. Particularly, expansion in the joint portion of the inner panel and the frame part and its surrounding part is restricted more compared to other portions. Therefore, in each member of the inner panel and the frame part, a difference is caused between the degree of expansion in heating in a region close to the joint portion and the degree of expansion in heating in a region far from the joint portion. This fact becomes a cause of occurrence of residual deformation in the inner panel and the frame part (sash part).

The object of the present invention is to provide a method for manufacturing a vehicular side door, a door component, and a side door capable of suppressing occurrence of residual deformation in a frame and a door panel member in a manufacturing step including a heating step even when the coefficient of linear expansion of a material configuring the frame included in a sash part and the coefficient of linear expansion of a material configuring the door panel member included in a door body part may be different from each other.

The method for manufacturing a vehicular side door of the present invention is a method for manufacturing a vehicular side door, the vehicular side door including at least one door panel member and a sash part, the door panel member being configured of a first material having a first coefficient of linear expansion, the sash part being joined to the at least one door panel member and being configured of a second material having a second coefficient of linear expansion that is different from the first coefficient of linear expansion. The method for manufacturing a vehicular side door includes joining each of one end part of a front frame configuring a front portion of the sash part in the vehicle longitudinal direction and one end part of a rear frame configuring a rear portion of the sash part in the vehicle longitudinal direction to the at least one door panel member, heating the at least one door panel member, the front frame, and the rear frame, and joining the other end part of the front frame and the other end part of the rear frame to each other.

According to this manufacturing method, the other end part of the front frame and the other end part of the rear frame are joined to each other after the heating. In a stage prior to the joining the other end part of the front frame and the other end part of the rear frame, the front frame and the rear frame do not restrict expansion and shrinkage of the door panel member, and do not restrain the door panel member. In a similar manner, the door panel member does not restrict expansion and shrinkage of the front frame and the rear frame, and does not restrain the front frame and the rear frame. Therefore, in the heating, each of the front frame, the rear frame, and the door panel member is allowed to expand and shrink comparatively freely. Also, after the heating, the other end part of the front frame and the other end part of the rear frame are joined to each other. Therefore, according to the method for manufacturing a vehicular side door of the present invention, even when the first coefficient of linear expansion of the first material configuring the door panel member and the second coefficient of linear expansion of the second material configuring the front frame and the rear frame may be different from each other, it is possible to suppress occurrence of residual deformation in the front frame, the rear frame, and the door panel member in the manufacturing step.

In the method for manufacturing a vehicular side door, it is preferable that the modulus of elasticity of the second material is greater than the modulus of elasticity of the first material, and the density of the second material is greater than the density of the first material.

This embodiment enables to suppress generation of the wind noise in the sash part and to suppress increase of the weight of the vehicular side door in addition to the effect of suppressing the residual deformation described above. Concretely, when a vehicle such as an automobile travels, there is a case that the sash part is sucked outward in the vehicle width direction by negative pressure applied to the window glass surface of the side door and undergoes slight flexural deformation. When the travel speed of the vehicle increases in particular, the flexural deformation amount of the sash part outward in the vehicle width direction with respect to the vehicle body also becomes large. Normally, although the side door and the vehicle body are tightly sealed through a rubber-made sealing part and the like, when the flexural deformation amount described above becomes large, a gap is formed between the side door and the vehicle body, and the wind noise is thereby generated. According to the present embodiment, the modulus of elasticity of the second material configuring the front frame and the rear frame is greater than the modulus of elasticity of the first material configuring the door panel member, and the density of the second material is greater than the density of the first material. This fact enables to impart rigidity to the sash part to suppress generation of the wind noise and to reduce the weight of the door panel member to suppress increase of the weight of the vehicular side door. Also, to impart rigidity to the sash part enables to suppress increase of the cross-sectional size of the sash part and to secure the field of view of the occupant.

As a concrete example of combination of the material as described above, it is possible to cite an embodiment that the first material is an aluminum alloy, and the second material is steel.

In the method for manufacturing a vehicular side door, it is preferable that the joining each of the one end part of the front frame and the one end part of the rear frame includes allowing an adhesive agent to be interposed between each of the one end part of the front frame and the one end part of the rear frame and the at least one door panel member.

This embodiment enables to improve the rigidity of the front frame and the rear frame, and to suppress occurrence of electric corrosion between dissimilar metals. Concretely, according to this embodiment, in the joining portion of the one end part of the front frame and the door panel member and the joining portion of the one end part of the rear frame and the door panel member, the joining method by the adhesive agent described above and another joining method other than that by the adhesive agent are used together. Sine the respective joining portions are joined by the another joining method and are joined by the adhesive agent described above, the one end part of each of the front frame and the rear frame (namely the root portion of these frames) is fixed to the door panel member more solidly compared to the case only the another joining method is used. Accordingly, the front frame and the rear frame are strongly restrained at the root portion described above, and rigidity of the front frame and the rear frame improves as a result. Also, since the adhesive agent is interposed between the front frame and the rear frame and the door panel member, occurrence of electric corrosion between dissimilar metals is suppressed. Further, although the another joining method is not particularly limited as far as it satisfies the joining property required for a side door, as a concrete example of the another joining method, a joining method by welding, a joining method by rivets, and so on can be cited.

In the method for manufacturing a vehicular side door, it is preferable that the second material is an aluminum-plated steel sheet.

This embodiment enables to join each of the front frame and the rear frame to the door panel member by spot welding. To be more specific, in general, it is hard to spot-weld a sheet made of an aluminum alloy and a steel sheet to each other. According to the present embodiment, since the second material configuring each of the front frame and the rear frame is an aluminum-plated steel sheet, it becomes possible to join each of the front frame and the rear frame to the door panel member that is formed using an aluminum alloy by spot welding.

In the method for manufacturing a vehicular side door, it is preferable that the at least one door panel member includes one panel out of an inner panel and an outer panel, and a reinforcement member disposed along the vehicle longitudinal direction for reinforcing the one panel, and the joining each of the one end part of the front frame and the one end part of the rear frame includes joining the reinforcement member to the one panel and joining each of the one end part of the front frame and the one end part of the rear frame to the reinforcement member so as to allow the reinforcement member to be interposed between each of the one end part of the front frame and the one end part of the rear frame and the one panel.

According to this embodiment, even when the reinforcement member is arranged in the one panel along the vehicle longitudinal direction, it can be suppressed to generate residual deformation in the front frame, the rear frame, and the door panel member in the manufacturing step.

In the method for manufacturing a vehicular side door, it is preferable that the joining each of the one end part of the front frame and the one end part of the rear frame includes a temporarily fixing, and the temporarily fixing includes overlaying the other end part of the front frame and the other end part of the rear frame on each other and temporarily fixing the other end part of the front frame and the other end part of the rear frame to each other so as to allow the other end part of the front frame and the other end part of the rear frame to be relatively displaced with each other in the heating.

According to this embodiment, it is allowed that the other end part of the front frame and the other end part of the rear frame having been temporarily fixed in the temporarily fixing are relatively displaced with each other in the heating. That is, according to this embodiment, since the other end parts have been temporarily fixed to each other, the other end part of the front frame and the other end part of the rear frame are suppressed from departing from each other in the heating. This facilitates the other end parts to be joined to each other in the joining the other end part of the front frame and the other end part of the rear frame that is executed after the heating.

In the method for manufacturing a vehicular side door, it is preferable that the temporarily fixing includes temporarily fixing the other end part of the front frame and the other end part of the rear frame to each other by a bolt with first fastening torque that allows the other end part of the front frame and the other end part of the rear frame to be relatively displaced with each other in the heating, at least one of the other end part of the front frame and the other end part of the rear frame includes a bolt insertion hole to which the bolt is inserted, and the bolt insertion hole has a dimension that allows the other end part of the front frame and the other end part of the rear frame to be relatively displaced with each other in the heating.

According to this embodiment, by comparatively simple configuration and method of adjusting the fastening torque of the bolt, the other end parts can be temporarily fixed to each other in the temporarily fixing, and these other end parts are allowed to be relatively displaced with each other in the heating.

In the method for manufacturing a vehicular side door, it is preferable that the bolt insertion hole is an elongated hole whose dimension in a specific direction is greater than a dimension in a direction orthogonal to the specific direction.

According to this embodiment, for example, when the elongated hole is formed so that the longitudinal direction of the elongated hole extends along a direction along which the other end parts are relatively displaced with each other in the heating, the other end parts are allowed to be relatively displaced with each other along the longitudinal direction of the elongated hole in the heating.

In the method for manufacturing a vehicular side door, it is preferable that the dimension in the specific direction has a size in the vehicle longitudinal direction of the bolt insertion hole, and the dimension in a direction orthogonal to the specific direction has a size in the vehicle vertical direction of the bolt insertion hole.

This embodiment enables to suppress the contact area of the head part of the bolt and the surface of the front frame or the rear frame continuing to the edge defining the elongated hole from becoming small. Concretely, the front frame is normally fixed to the front end part of the door panel member and the rear frame is normally fixed to the rear end part of the door panel member, and therefore variation of the relative position of the front frame and the rear frame is liable to be affected by expansion and shrinkage of the door panel member in the vehicle longitudinal direction. That is, the relative position of the front frame and the rear frame tends to vary in the vehicle longitudinal direction or in a direction near the vehicle longitudinal direction. Accordingly, since the bolt insertion hole is such an elongated hole as described above, the specific direction in the elongated hole can be brought close to a direction where variation of the relative position of the front frame and the rear frame is large. Thus, the dimension of the elongated hole in the direction orthogonal to the specific direction can be made smaller compared to the dimension of the elongated hole in the specific direction. This fact enables to suppress the contact area of the head part of the bolt and the surface of the frames continuing to the edge defining the elongated hole from becoming small.

In the method for manufacturing a vehicular side door, it is preferable that the joining the other end part of the front frame and the other end part of the rear frame includes joining the other end part of the front frame and the other end part of the rear frame to each other by the bolt with second fastening torque that is greater than the first fastening torque.

According to this embodiment, the bolt that temporarily fixes the other end part of the front frame and the other end part of the rear frame to each other in the temporarily fixing is used also when these other end parts are joined to each other in the joining the other end part of the front frame and the other end part of the rear frame. Therefore, this embodiment enables temporarily fixing in the temporarily fixing and joining in the joining the other end part of the front frame and the other end part of the rear frame by comparatively simple configuration and method of adjusting fastening torque of a bolt.

The door component of the present invention includes at least one door panel member configured of a first material having a first coefficient of linear expansion and a sash part joined to the at least one door panel member and configured of a second material having a second coefficient of linear expansion that is different from the first coefficient of linear expansion, the sash part includes a front frame configuring a front portion in the vehicle longitudinal direction and a rear frame configuring a rear portion in the vehicle longitudinal direction, each of one end part of the front frame and one end part of the rear frame includes a joint part that is joined to the at least one door panel member, and at least one of the front frame and the rear frame includes a temporarily fixing part for temporarily fixing the other end part of the front frame and the other end part of the rear frame to each other so as to allow the other end part of the front frame and the other end part of the rear frame to be relatively displaced with each other.

According to the door component of the present invention, by using the door component for manufacturing of a vehicular side door, even when the coefficient of linear expansion of the material configuring the front frame and the rear frame and the coefficient of linear expansion of the material configuring the door panel member may be different from each other, it can be suppressed to generate residual deformation in the front frame, the rear frame, and the door panel member in the manufacturing step.

In the door component, it is preferable that the modulus of elasticity of the second material is greater than the modulus of elasticity of the first material, and the density of the second material is greater than the density of the first material.

This embodiment enables to suppress generation of the wind noise in the sash part and to suppress increase of the weight of the vehicular side door in addition to the effect of suppressing the residual deformation described above. Also, since rigidity is imparted to the sash part, it is enabled to suppress increase of the cross-sectional size of the sash part and to secure the field of view of the occupant.

As a concrete example of combination of such materials as described above, such an embodiment can be cited that the first material is an aluminum alloy, and the second material is steel.

In the door component, it is preferable that the at least one door panel member includes one panel out of an inner panel and an outer panel, and a reinforcement member disposed along the vehicle longitudinal direction for reinforcing the one panel, the reinforcement member is joined to the one panel, and each of the one end part of the front frame and the one end part of the rear frame is joined to at least one of the one panel and the reinforcement member.

According to this embodiment, even when the reinforcement member may be arranged along the vehicle longitudinal direction in the one panel, it can be suppressed to generate residual deformation in the front frame, the rear frame, and the door panel member in the manufacturing step.

In the door component, it is preferable that at least one of the other end part of the front frame and the other end part of the rear frame includes a bolt insertion hole to which a bolt is inserted, the bolt being for temporarily fixing the other end parts to each other, and the bolt insertion hole has a dimension that allows the other end part of the front frame and the other end part of the rear frame to be relatively displaced with each other.

According to this embodiment, by comparatively simple configuration and method of adjusting the fastening torque of the bolt, the other end parts can be temporarily fixed to each other in the temporarily fixing, and these other end parts are allowed to be relatively displaced with each other in the heating.

In the door component, it is preferable that the bolt insertion hole is an elongated hole whose dimension in a specific direction is greater than a dimension in a direction orthogonal to the specific direction.

According to this embodiment, for example, when the elongated hole is formed so that the longitudinal direction of the elongated hole extends along a direction along which the other end parts are relatively displaced with each other in the heating, the other end parts are allowed to be relatively displaced with each other along the longitudinal direction of the elongated hole in the heating.

In the door component, it is preferable that the dimension in the specific direction has a size in the vehicle longitudinal direction of the bolt insertion hole, and the dimension in a direction orthogonal to the specific direction has a size in the vehicle vertical direction of the bolt insertion hole.

This embodiment enables to suppress the contact area of the head part of the bolt and the surface of the front frame or the rear frame continuing to the edge defining the elongated hole from becoming small.

The side door of the present invention includes at least one door panel member configured of a first material having a first coefficient of linear expansion and a sash part joined to the at least one door panel member and configured of a second material having a second coefficient of linear expansion that is different from the first coefficient of linear expansion, the sash part includes a front frame configuring a front portion in the vehicle longitudinal direction and a rear frame configuring a rear portion in the vehicle longitudinal direction, each of one end part of the front frame and one end part of the rear frame includes a first joint part that is joined to the at least one door panel member, and at least one of the other end part of the front frame and the other end part of the rear frame includes a second joint part where a temporarily fixed state is made to be a joined state, the temporarily fixed state allowing the other end part of the front frame and the other end part of the rear frame to be relatively displaced with each other, the other end part of the front frame and the other end part of the rear frame being joined to each other in the joined state.

According to the side door of the present invention, even when the coefficient of linear expansion of the material configuring the front frame and the rear frame and the coefficient of linear expansion of the material configuring the door panel member may be different from each other, it can be suppressed to generate residual deformation in the front frame, the rear frame, and the door panel member in the manufacturing step of the side door.

As a concrete example of the joining the other end part of the front frame and the other end part of the rear frame, it is preferable that the second joint part includes a bolt insertion hole to which a bolt is inserted, the bolt being for joining the other end part of the front frame and the other end part of the rear frame to each other, and the bolt insertion hole is an elongated hole whose dimension in a specific direction is greater than a dimension in a direction orthogonal to the specific direction.

According to this embodiment, by comparatively simple configuration and method of adjusting the fastening torque of the bolt, the other end parts can be temporarily fixed to each other in the temporarily fixing, and these other end parts are allowed to be relatively displaced with each other in the heating.

As described above, according to the present invention, even when the coefficient of linear expansion of a material configuring a frame included in a sash part and the coefficient of linear expansion of a material configuring a door panel member included in a door body part may be different from each other, it is possible to suppress occurrence of residual deformation in the frame and the door panel member in a manufacturing step including a heating.

### BRIEF DESCRIPTION OF DRAWINGS

FIG. 1 is a side view that illustrates a vehicular side door manufactured using a manufacturing method related to an embodiment of the present invention.

FIG. 2 is a cross-sectional view taken along the line II-II of FIG. 1.

FIG. 3 is a cross-sectional view taken along the line III-III of FIG. 1.

FIG. 4 is an enlarged side view of a portion surrounded by a single dot chain line IV of FIG. 1.

FIG. 5A is a cross-sectional view taken along the line V-V of FIG. 4.

FIG. 5B is a cross-sectional view that illustrates a state the upper end part (other end part) of a front frame and the upper end part (other end part) of a rear frame are relatively displaced with each other.

FIG. 5C is a cross-sectional view that illustrates a state the upper end part (other end part) of the front frame and the upper end part (other end part) of the rear frame are relatively displaced with each other.

FIG. 6 is a drawing that illustrates a step of a method for manufacturing a vehicular side door related to an embodiment of the present invention.

FIG. 7A is a side view that illustrates a summary of the step of the manufacturing method.

FIG. 7B is a side view that illustrates a summary of the step of the manufacturing method.

FIG. 7C is a side view that illustrates a summary of the step of the manufacturing method.

FIG. 7D is a side view that illustrates a summary of the step of the manufacturing method.

FIG. 7E is a side view that illustrates a summary of the step of the manufacturing method.

FIG. 8 is a side view that illustrates a side door including a door component related to a first modification of the embodiment.

FIG. 9 is a side view that illustrates a side door including a door component related to a second modification of the embodiment.

FIG. 10 is a side view that illustrates a side door including a door component related to a third modification of the embodiment.

FIG. 11 is a side view that illustrates a side door including a door component related to a fourth modification of the embodiment.

FIG. 12 is a cross-sectional view that illustrates a modification of the front frame.

### DESCRIPTION OF EMBODIMENTS

Preferable embodiments of the present invention will be explained referring to the drawings.

### [Structure of Side Door]

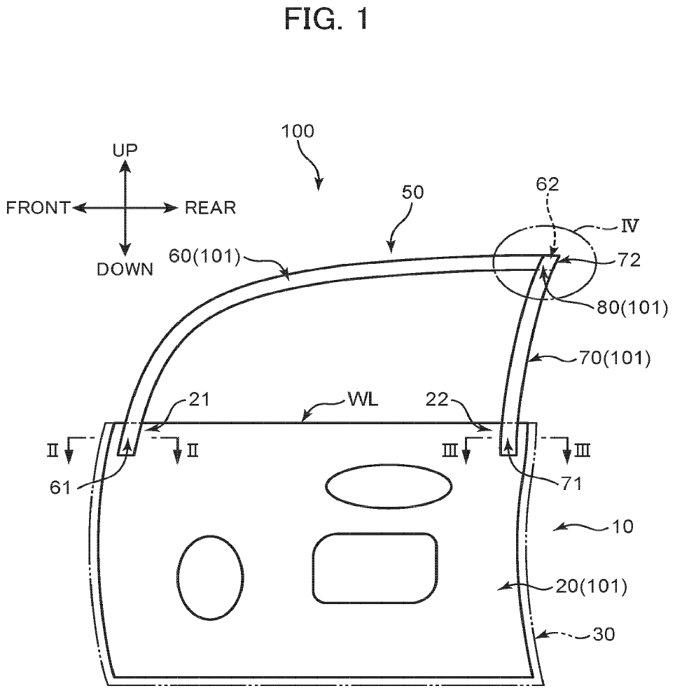

FIG. 1 is a side view that illustrates a vehicular side door 100 manufactured using a manufacturing method related to the embodiment, and is a drawing when the side door 100 is seen from the outer side in the vehicle width direction of a vehicle. Although the side door 100 illustrated in FIG. 1 is a side door on the front side of the vehicle (front side door), a side door manufactured using a method for manufacturing a vehicular side door of the present invention may be a side door on the rear side of a vehicle (rear side door).

Also, letters and arrows of “front”, “rear”, “up”, “down”, “out”, and “in” illustrated from time to time in the drawings illustrate directions based on the vehicle longitudinal direction and the vehicle width direction and are directions when the side door 100 is in a state of closing the door opening part of the vehicle body whose illustration is omitted (door closed state). Therefore, the letter and arrow of the “out” illustrate the outer side in the vehicle width direction, and the letter and arrow of the “in” illustrate the inner side in the vehicle width direction.

As illustrated in FIG. 1, the side door 100 includes a door body part 10 and a sash part 50. The door body part 10 is positioned below a waistline WL of the side door 100. The door body part 10 includes an inner panel 20, an outer panel 30, and a reinforcement member, the inner panel 20 configuring a surface on the inner side in the vehicle width direction, the outer panel 30 configuring a surface on the outer side in the vehicle width direction of the side door 100, the reinforcement member being disposed between these panels 20, 30, illustration of the reinforcement member being omitted. In FIG. 1, with respect to the outer panel 30, only the contour is illustrated by a two-dot chain line. Also, according to the present embodiment, the inner panel 20 configures a door panel member.

The outer panel 30 is joined to the inner panel 20 for example by that the end part in the vehicle longitudinal direction and the end part in the vertical direction are subjected to hemming work. Each of the inner panel 20 and the outer panel 30 is manufactured by press forming of a metal sheet for example.

The sash part 50 forms a window frame for a window glass above the door body part 10. The sash part 50 includes a front frame 60 and a rear frame 70, the front frame 60 configuring the front portion of the sash part 50, the rear frame 70 configuring the rear portion of the sash part 50. The front frame 60 is a member extending upward while curving rearward along a side rail of the vehicle body whose illustration is omitted in the door closed state, and the rear frame 70 is a member extending upward along a center pillar of the vehicle body whose illustration is omitted.

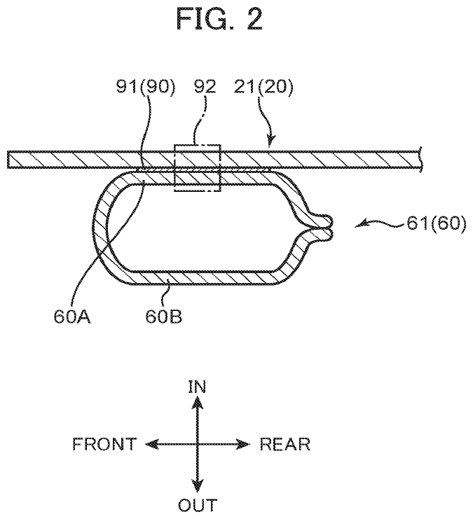

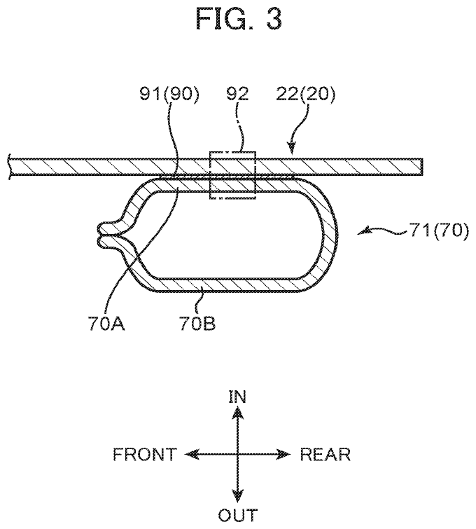

FIG. 2 is a cross-sectional view taken along the line II-II of FIG. 1, and FIG. 3 is a cross-sectional view taken along the line III-III of FIG. 1.

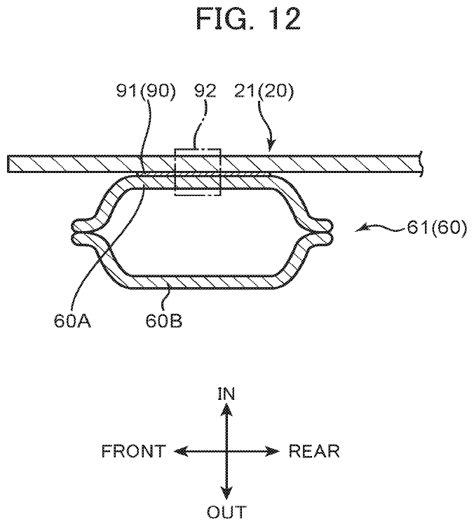

As illustrated in FIG. 2 and FIG. 3, each of the front frame 60 and the rear frame 70 has a closed cross section structure excellent in rigidity and a channel cross section structure forming a groove part for storing an edge of the window glass for example, illustration of the groove part being omitted. In FIG. 2 and FIG. 3, illustration of the channel cross section structure is omitted. As illustrated in FIG. 2, the closed cross section structure in the front frame 60 is formed by an inner portion 60A positioned on the inner side in the vehicle width direction and an outer portion 60B positioned on the outer side in the vehicle width direction. As illustrated in FIG. 3, the closed cross section structure in the rear frame 70 is formed by an inner portion 70A positioned on the inner side in the vehicle width direction and an outer portion 70B positioned on the outer side in the vehicle width direction. However, the structure of these frames 60, 70 is not limited to the concrete examples illustrated in FIG. 2 and FIG. 3. According to the present embodiment, although each of the front frame 60 and the rear frame 70 is manufactured by roll forming of a metal sheet, it may be one manufactured by a method other than roll forming such as press forming for example. When the press forming is to be used, as illustrated in the cross-sectional view of FIG. 12 for example, the inner portion 60A of the front frame 60 and the outer portion 60B of the front frame 60 are joined to each other using a joining method such as welding for example after being individually formed by the press forming. Although illustration of the cross-sectional structure of the rear frame 70 of a case of using the press forming is omitted, it is similar to the cross-sectional structure of the front frame 60 illustrated in FIG. 12.

The front frame 60 includes a lower end part 61 (an example of one end part) and an upper end part 62 (an example of the other end part), the lower end part 61 being fixed to a front end part 21 of the inner panel 20, the upper end part 62 being located on the opposite side of the lower end part 61. The rear frame 70 includes a lower end part 71 (an example of one end part) and an upper end part 72 (an example of the other end part), the lower end part 71 being fixed to a rear end part 22 of the inner panel 20, the upper end part 72 being located on the opposite side of the lower end part 71. Concretely, the lower end part 61 of the front frame 60 is fixed to the front end part 21 that is positioned in the upper part of the inner panel 20, and the lower end part 71 of the rear frame 70 is fixed to the rear end part 22 that is positioned in the upper part of the inner panel 20. The rear frame 70 extends toward the upper end part 62 of the front frame 60 from the lower end part 71 of the rear frame 70.

As illustrated in FIG. 2, to the front end part 21 of the inner panel 20, the lower end part 61 of the front frame 60 is joined by an adhesion layer 91 formed by an adhesive agent 90 and is joined at a first joint part 92 that is formed by a joining method other than that by the adhesive agent 90. In a similar manner, as illustrated in FIG. 3, to the rear end part 22 of the inner panel 20, the lower end part 71 of the rear frame 70 is joined by the adhesion layer 91 formed by the adhesive agent 90 and is joined at the first joint part 92 that is formed by a joining method other than that by the adhesive agent 90. As the other joining method for joining the first joint part 92, a joining method by welding, a joining method by rivets, and so on can be cited for example.

Each of the front frame 60 and the rear frame 70 is configured of a material whose coefficient of linear expansion is different from the coefficient of linear expansion of a material configuring the inner panel 20. Concretely, each of the front frame 60 and the rear frame 70 is configured of steel (an example of a second material having a second coefficient of linear expansion), and the inner panel 20 is configured of an aluminum alloy (an example of a first material having a first coefficient of linear expansion). As the aluminum alloy, a 5000-series aluminum alloy, a 6000-series aluminum alloy, a 7000-series aluminum alloy, and the like are used for example. Also, it is preferable that each of the front frame 60 and the rear frame 70 is one formed using an aluminum-plated steel sheet. Further, the outer panel 30 is configured of an aluminum alloy.

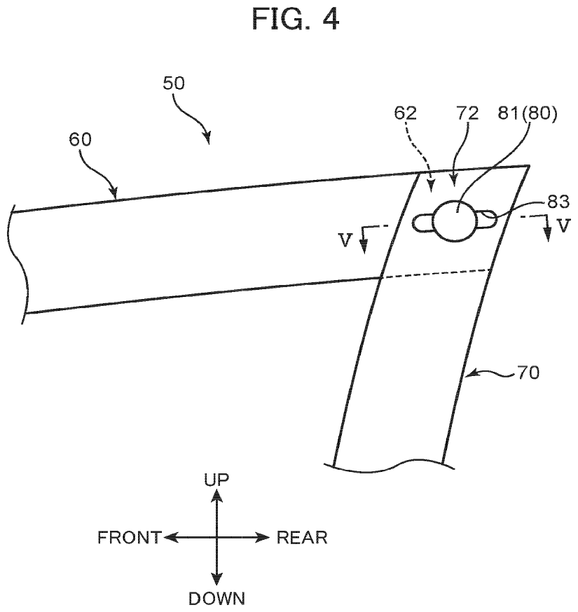

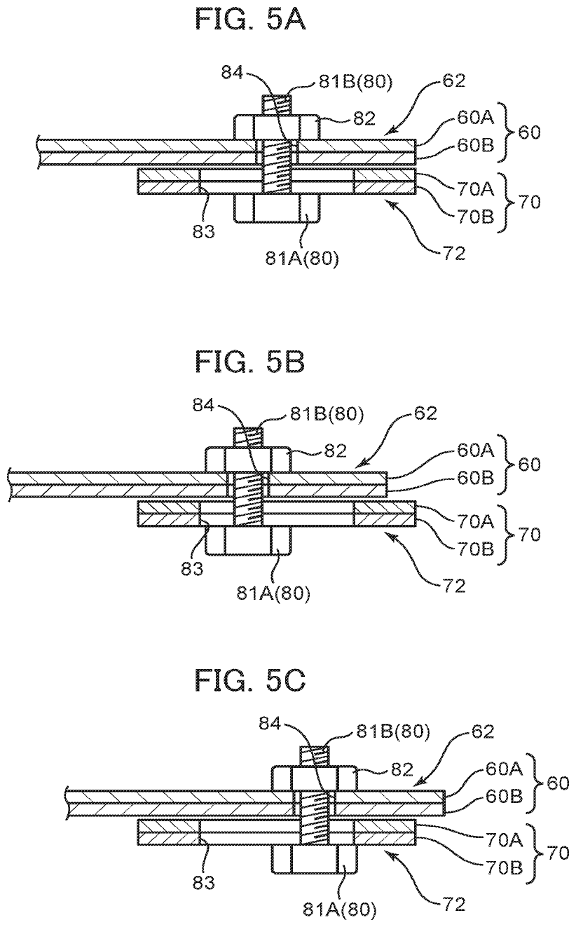

FIG. 4 is an enlarged side view of a portion surrounded by a single dot chain line IV of FIG. 1, and FIG. 5A is a cross-sectional view taken along the line V-V of FIG. 4. As illustrated in FIG. 4 and FIG. 5A, the upper end part 62 of the front frame 60 and the upper end part 72 of the rear frame 70 are fixed to each other. According to the present embodiment, these upper end parts 62, 72 are fixed to each other by a bolt 81 and a nut 82. Concretely, the upper end part 62 of the front frame 60 includes an insertion hole 84, the upper end part 72 of the rear frame 70 includes an insertion hole 83, and the nut 82 is screwed to the bolt 81 in a state the bolt 81 is inserted to these insertion holes 83, 84. Thus, the upper end parts 62, 72 are fixed to each other. Also, the bolt 81, the nut 82, and the insertion holes 83, 84 are an example of a temporarily fixing part in the present invention, and are an example of the second joint part. Also, the bolt 81 and the nut 82 configure a temporarily fixing member 80 used for a manufacturing method of the side door 100 related to the present embodiment explained below.

[Manufacturing Method of Side Door]

Next, a manufacturing method of the side door 100 related to the present embodiment will be explained.

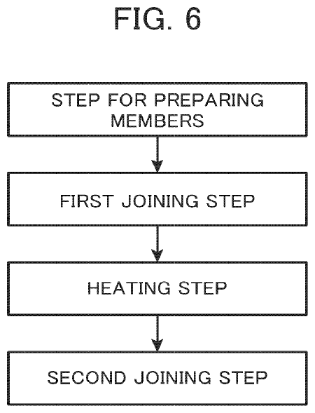

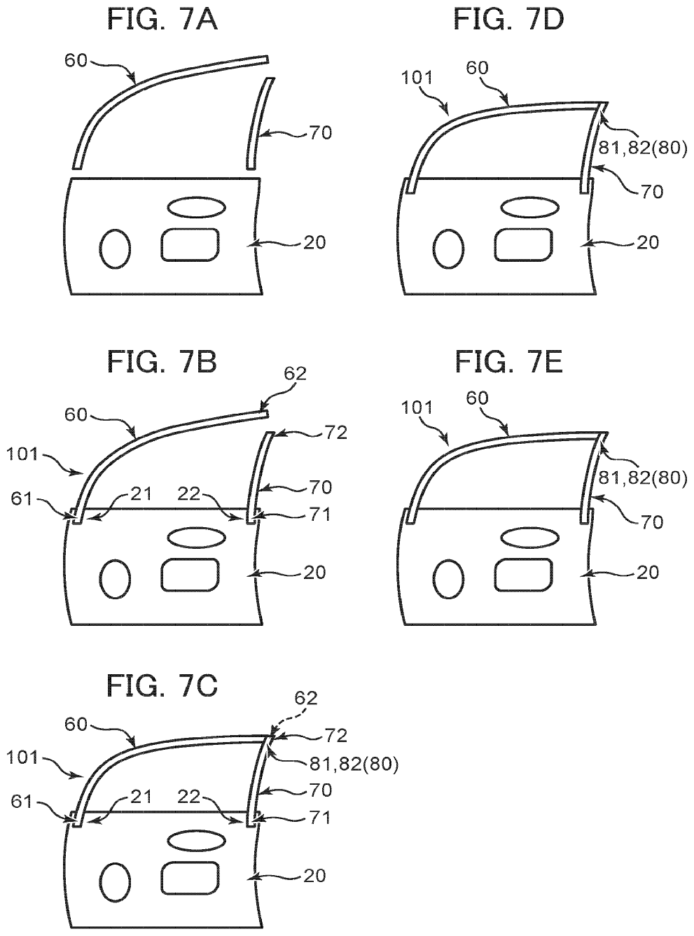

Each of FIG. 5B and FIG. 5C is a cross-sectional view that illustrates a state the upper end part 62 of the front frame 60 and the upper end part 72 of the rear frame 70 are relatively displaced with each other from a state illustrated in FIG. 5A FIG. 6 is a drawing that illustrates a step of a manufacturing method related to the present embodiment, and FIG. 7A to FIG. 7E are side views that illustrate a summary of the step of the manufacturing method.

As illustrated in FIG. 6, the manufacturing method related to the present embodiment includes a step for preparing members, a first joining step, a heating step, and a second joining step. The step for preparing members corresponds to the side view FIG. 7A, the first joining step corresponds to the side views FIG. 7B and FIG. 7C, the heating step corresponds to the side view FIG. 71), and the second joining step corresponds to the side view FIG. 7E. Also, in FIG. 7A to FIG. 7E, illustration of the outer panel 30 is omitted.

The step for preparing members illustrated in FIG. 7A includes a step for preparing the inner panel 20, a step for preparing the outer panel 30, a step for preparing the front frame 60, and a step for preparing the rear frame 70. Each of the inner panel 20 and the outer panel 30 is manufactured by press-forming of a metal sheet made of an aluminum alloy for example. Each of the front frame 60 and the rear frame 70 is manufactured by roll-forming or press-forming of a steel sheet for example.

The first joining step illustrated in FIG. 7B and FIG. 7C includes a step for forming a door component 101 (FIG. 7B) and a temporarily fixing step (FIG. 7C) used for the manufacturing method. The door component 101 includes the inner panel 20, the front frame 60, the rear frame 70, and the temporarily fixing member 80 that is used in the temporarily fixing step. The door component 101 is manufactured by that the lower end part 61 of the front frame 60 is joined to the front end part 21 of the inner panel 20 and that the lower end part 71 of the rear frame 70 is joined to the rear end part 22 of the inner panel 20.

In the door component 101 having been manufactured, the front frame 60 is disposed so as to extend upward while curving rearward from the front end part 21 that is positioned in the upper part of the inner panel 20, and the rear frame 70 is disposed so as to extend upward while curving rearward from the rear end part 22 that is positioned in the upper part of the inner panel 20. The rear frame 70 is disposed so as to extend toward the upper end part 62 of the front frame 60 from the lower end part 71 of the rear frame 70.

The temporarily fixing step includes overlaying the upper end part 62 (an example of the other end part) of the front frame 60 and the upper end part 72 (an example of the other end part) of the rear frame 70 on each other and temporarily fixing the upper end part 62 of the front frame 60 and the upper end part 72 of the rear frame 70 to each other so as to allow the upper end part 62 of the front frame 60 and the upper end part 72 of the rear frame 70 to be relatively displaced with each other in the heating step while keeping the state of overlaying these upper end parts 62, 72 on each other. Followings are more specific explanation.

The temporarily fixing step illustrated in FIG. 7C is a step for temporarily fixing the upper end part 62 of the front frame 60 and the upper end part 72 of the rear frame 70 to each other using the temporarily fixing member 80. According to the present embodiment, the temporarily fixing member 80 is configured of the bolt 81 and the nut 82. The temporarily fixing step is a step executed prior to the heating step.

Concretely, according to the present embodiment, the temporarily fixing step includes inserting the bolt 81 to the bolt insertion holes 83, 84 (refer to FIG. 4, FIG. 5A, FIG. 5B, and FIG. 5C), and temporarily fixing these upper end parts 62, 72 to each other by the bolt 81 with the first fastening torque that allows the upper end part 62 of the front frame 60 and the upper end part 72 of the rear frame 70 to be relatively displaced with each other in the heating step.

As illustrated in FIG. 4, FIG. 5A, FIG. 5B, and FIG. 5C, the bolt insertion hole 83 arranged in the rear frame 70 has a dimension allowing a shaft part 81B of the bolt 81 inserted to the bolt insertion hole 83 to be relatively displaced with respect to the bolt insertion hole 83. That is, the bolt insertion hole 83 is an elongated hole where a dimension in a specific direction is larger than a dimension in a direction orthogonal to the specific direction. According to the present embodiment, the dimension in the specific direction corresponds to a size in the vehicle longitudinal direction of the bolt insertion hole 83, and the dimension in the direction orthogonal to the specific direction corresponds to a size in the vertical direction of the vehicle of the bolt insertion hole 83. According to the present embodiment, the dimension in the specific direction of the elongated hole is larger than the width in a head part 81A of the bolt 81 (the size of the head part 81A in a direction orthogonal to the axial direction of the shaft part 81B), and the dimension in the direction orthogonal to the specific direction of the elongated hole is smaller than the width in the head part 81A of the bolt 81. However, the dimension in the specific direction of the elongated hole may be smaller than the width in the head part 81A of the bolt 81. The surface of the head part 81A opposes the surface of the rear frame 70 in the axial direction, the surface of the rear frame 70 continuing to the edge that defines the elongated hole.

According to the present embodiment, as illustrated in FIG. 4, the specific direction of the elongated hole is generally the vehicle longitudinal direction. Also, the bolt insertion hole 83 arranged in the rear frame 70 is not limited to an elongated hole, and may have other hole shapes such as a hole of a circular shape and a hole of a polygonal shape. Further, it is also possible that the bolt insertion hole 84 of the front frame 60 is an elongated hole and the bolt insertion hole 83 of the rear frame 70 has the other hole shape other than the elongated hole. Furthermore, each of the bolt insertion hole 84 of the front frame 60 and the bolt insertion hole 83 of the rear frame 70 may have the other hole shape other than the elongated hole.

The heating step illustrated in FIG. 7D is a step for heating the door component 101 that is obtained by temporarily fixing the upper end part 62 of the front frame 60 and the upper end part 72 of the rear frame 70 to each other in the temporarily fixing step. In other words, the heating step is a step for heating the door component 101 in a state the upper end part 62 of the front frame 60 and the upper end part 72 of the rear frame 70 are not fixed to each other. According to the present embodiment, the heating step is a baking step (drying step) executed after the door component 101 is painted.

The second joining step illustrated in FIG. 7E is a step for fixing (joining) the upper end part 62 of the front frame 60 and the upper end part 72 of the rear frame 70 to each other after the heating step in a state the temperature of the door component 101 has lowered than the temperature in the heating step. In the second joining step in the present embodiment, the upper end parts 62, 72 are fixed to each other in a state the temperature of the door component 101 has lowered to the temperature of the surrounding environment (ordinary temperature) after the heating step. In the second joining step, these upper end parts 62, 72 are fixed to each other in a state of overlaying the upper end part 62 of the front frame 60 and the upper end part 72 of the rear frame 70 on each other.

According to the present embodiment, the upper end parts 62, 72 are fixed to each other using the bolt 81 and the nut 82. That is, the temporarily fixing member 80 used in the temporarily fixing step is also used as a fixing member 80 (joining member) in the second joining step. Concretely, in the second joining step, the upper end part 62 of the front frame 60 and the upper end part 72 of the rear frame 70 are fixed to each other by the bolt 81 with second fastening torque that is larger than the first fastening torque in the temporarily fixing step. Also, the fixing method (joining method) for fixing the upper end parts 62, 72 to each other in the second joining step is not limited to one using the bolt 81 and the nut 82, and may be a fixing method by welding, a fixing method by rivets, and so on for example.

In the second joining step, with respect to the second joint part, the temporarily fixed state allowing the upper end part 62 of the front frame 60 and the upper end part 72 of the rear frame 70 to be relatively displaced with each other (a state illustrated in FIG. 7C) is changed to the joining state where the upper end part 62 of the front frame 60 and the upper end part 72 of the rear frame 70 are joined to each other (the fixing state illustrated in FIG. 7E).

After the second joining step, the outer panel 30 is connected to the inner panel 20 for example by subjecting the end part in the vehicle longitudinal direction and the end part in the vertical direction to hemming work, other members are attached to the inner panel 20, the outer panel 30, and the like according to the necessity, and thereby the side door 100 is manufactured.

As explained above, according to the manufacturing method related to the present embodiment, although the lower end part 61 of the front frame 60 and the lower end part 71 of the rear frame 70 are respectively joined to the front end part 21 and the rear end part 22 of the inner panel 20 in the door component 101 at the time point when the heating step is executed, the upper end parts 62, 72 of these front frame 60 and rear frame 70 are not fixed to each other. Therefore, in the heating step, the front frame 60 and the rear frame 70 do not restrict expansion and shrinkage of the inner panel 20 and do not restrain the inner panel 20. In a similar manner, in the heating step, the inner panel 20 does not restrict expansion and shrinkage of the front frame 60 and the rear frame 70 and does not restrain these frames 60, 70.

Accordingly, in the heating step, each of the front frame 60, the rear frame 70, and the inner panel 20 is allowed to expand and shrink comparatively freely as illustrated in FIG. 5A to FIG. 5C. Also, after the heating step, in a state the temperature of the door component 101 has lowered than the temperature in the heating step, the upper end part 62 of the front frame 60 and the upper end part 72 of the rear frame 70 are fixed to each other. Therefore, according to the manufacturing method related to the present embodiment, even when the coefficient of linear expansion of the material configuring the front frame 60 and the rear frame 70 and the coefficient of linear expansion of the material configuring the inner panel 20 may be different from each other, it can be suppressed to generate residual deformation in the front frame 60, the rear frame 70, and the inner panel 20 in the manufacturing step.

Also, according to the present embodiment, the modulus of elasticity of the material configuring the front frame 60 and the rear frame 70 is greater than the modulus of elasticity of the material configuring the inner panel 20, and the density of the material configuring the inner panel 20 is smaller than the density of the material configuring the front frame 60 and the rear frame 70. This fact enables to suppress generation of the wind noise in the sash part 50 and to suppress increase of the weight of the vehicular side door. Also, to impart rigidity to the sash part 50 enables to suppress increase of the cross-sectional size of the sash part 50 and to secure the field of view of the occupant.

According to the present embodiment, the first joining step includes joining the lower end part 61 of the front frame 60 to the front end part 21 of the inner panel 20 using a joining method other than the joining method by the adhesive agent in a state of interposing an adhesive agent between the lower end part 61 of the front frame 60 and the front end part 21 of the inner panel 20, and joining the lower end part 71 of the rear frame 70 to the rear end part 22 of the inner panel 20 using the other joining method in a state of interposing an adhesive agent between the lower end part 71 of the rear frame 70 and the rear end part 22 of the inner panel 20. This fact enables to improve the rigidity of the front frame 60 and the rear frame 70, and to suppress occurrence of electric corrosion between dissimilar metals.

Also, when each of the front frame 60 and the rear frame 70 is one formed using an aluminum-plated steel sheet, the lower end part 61 of the front frame 60 and the lower end part 71 of the rear frame 70 can be joined to the front end part 21 and the rear end part 22 of the inner panel 20 by spot welding.

Further, according to the present embodiment, the upper end part 62 of the front frame 60 and the upper end part 72 of the rear frame 70 having been temporarily fixed to each other in the temporarily fixing step are allowed to be relatively displaced with each other while keeping a state these upper end parts 62, 72 are overlaid on each other in the heating step. Therefore, since the upper end part 62 of the front frame 60 and the upper end part 72 of the rear frame 70 are suppressed from departing from each other in the heating step, the second joining step of fixing these upper end parts 62, 72 to each other is facilitated. Also, in the present embodiment, the state of overlaying the upper end parts 62, 72 of the front frame 60 and the rear frame 70 on each other includes not only a case these upper end parts 62, 72 are in contact with each other but also a case these upper end parts 62, 72 oppose with each other at an interval.

According to the present embodiment, since the bolt insertion hole 83 is such an elongated hole as described above, the specific direction in the elongated hole can be brought close to a direction where variation of the relative position of the front frame 60 and the rear frame 70 is large. Thus, the dimension of the elongated hole in the direction orthogonal to the specific direction can be made smaller compared to the dimension of the elongated hole in the specific direction. This fact enables to suppress the contact area of the head part 81A of the bolt 81 and the surface of the rear frame 70 continuing to the edge that defines the elongated hole from becoming small.

According to the present embodiment, the bolt 81 that temporarily fixes the upper end part 62 of the front frame 60 and the upper end part 72 of the rear frame 70 to each other in the temporarily fixing step is used also in fixing these upper end parts 62, 72 to each other in the second joining step. This fact enables temporarily fixing in the temporarily fixing step and fixing in the second joining step by comparatively simple configuration and method of adjusting fastening torque of the bolt 81.

### [Modification]

The present invention is not limited to the embodiment explained above. The present invention includes such embodiments as described below for example.

### (A) First Modification

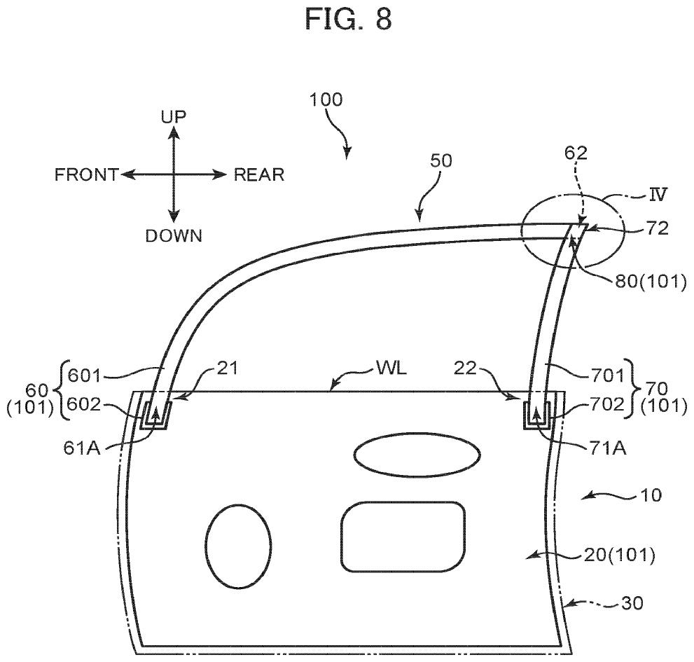

FIG. 8 is a side view that illustrates the side door 100 including the door component 101 related to the first modification of the embodiment. The door component 101 related to the first modification illustrated in FIG. 8 includes the inner panel 20, the front frame 60, the rear frame 70, and the temporarily fixing member 80 (the fixing member 80), the front frame 60 includes a frame body 601 and a bracket 602, and the rear frame 70 includes a frame body 701 and a bracket 702.

According to the first modification, a lower end part 61A of the frame body 601 in the front frame 60 is fixed to the front end part 21 of the inner panel 20 through the bracket 602, and a lower end part 71A of the frame body 701 in the rear frame 70 is fixed to the rear end part 22 of the inner panel 20 through the bracket 702. According to the first modification, the bracket 602 configures the lower end part of the front frame 60, and the bracket 702 configures the lower end part of the rear frame 70.

### (B) Second Modification

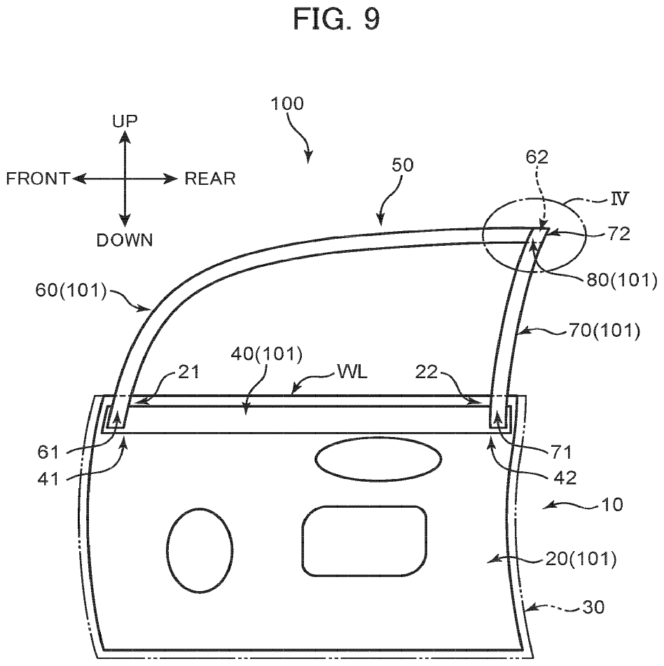

FIG. 9 is a side view that illustrates the side door 100 including the door component 101 related to the second modification of the embodiment. The door component 101 related to the second modification illustrated in FIG. 9 includes the inner panel 20, a reinforcement member 40, the front frame 60, the rear frame 70, and the temporarily fixing member 80 (the fixing member 80).

According to the second modification, the inner panel 20 and the reinforcement member 40 configure a door panel member in the present invention. The reinforcement member 40 is configured of a material whose coefficient of linear expansion is different from the coefficient of linear expansion of the material configuring the front frame 60 and the rear frame 70. Concretely, the reinforcement member 40 is configured of the same material as that of the inner panel 20. To be more specific, the reinforcement member 40 is configured of an aluminum alloy (an example of the first material having the first coefficient of linear expansion).

The reinforcement member 40 is a reinforcement member for reinforcing the inner panel 20, and is disposed along the vehicle longitudinal direction in the upper part of the inner panel 20. The reinforcement member 40 is joined to the inner panel 20. The reinforcement member 40 is a waist reinforcement that is disposed along the waistline WL. The lower end part 61 of the front frame 60 is fixed to a front end part 41 of the reinforcement member 40, and the lower end part 71 of the rear frame 70 is fixed to a rear end part 42 of the reinforcement member 40.

According to this second modification, the first joining step includes joining the reinforcement member 40 to the inner panel 20 so that the reinforcement member 40 is interposed between each of the lower end part 61 of the front frame 60 and the lower end part 71 of the rear frame 70 and the inner panel 20, and joining each of the lower end part 61 of the front frame 60 and the lower end part 71 of the rear frame 70 to the reinforcement member 40.

### (C) Third Modification

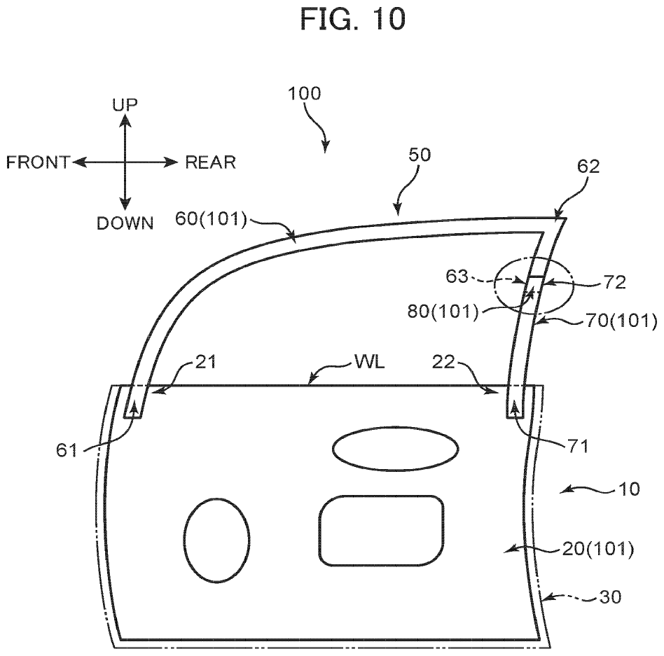

FIG. 10 is a side view that illustrates the side door 100 including the door component 101 related to the third modification of the embodiment.

The door component 101 related to the third modification is different from the door component 101 illustrated in FIG. 1 in the following point. That is, as illustrated in FIG. 10, the other end part 63 (an end part on the opposite side of the lower end part 61) of the front frame 60 is configured not by the upper end part 62 of the front frame 60 but by a lower end part of a portion that curves downward from the upper end part 62 and extends downward. The other end part 63 is fixed to the upper end part 72 of the rear frame 70.

Further, although illustration is omitted, the other end part (an end part on the opposite side of the lower end part 71) of the rear frame 70 may be configured not by the upper end part of the rear frame 70 but by a front end part of a portion that extends forward further beyond the upper end part. In such a case, the other end part is fixed to the upper end part of the front frame 60.

### (D) Fourth Modification

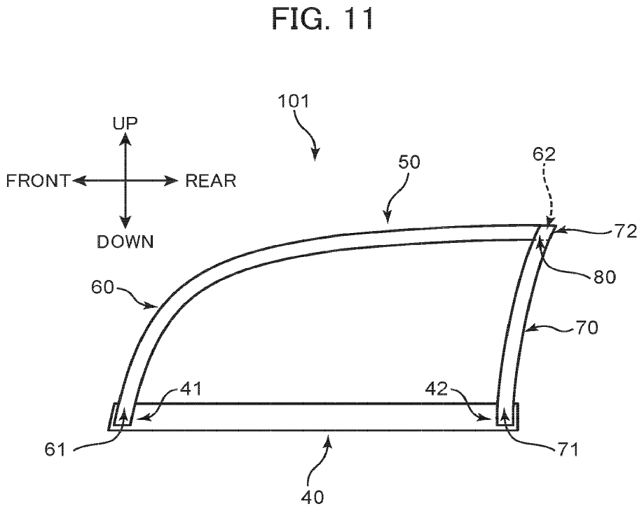

FIG. 11 is a side view that illustrates the door component 101 related to the fourth modification of the embodiment. The door component 101 related to the fourth modification illustrated in FIG. 11 includes the reinforcement member 40, the front frame 60, the rear frame 70, and the temporarily fixing member 80 (the fixing member 80).

According to the fourth modification, the reinforcement member 40 configures the door panel member in the present invention. The reinforcement member 40 is configured of a material whose coefficient of linear expansion is different from the coefficient of linear expansion of the material configuring the front frame 60 and the rear frame 70. Concretely, the reinforcement member 40 is configured of an aluminum alloy (an example of the first material having the first coefficient of linear expansion).

The reinforcement member 40 is a reinforcement member for reinforcing at least one panel out of the inner panel 20 and the outer panel 30 for example, is disposed along the vehicle longitudinal direction in the upper part of the at least one panel, and is joined to the at least one panel. The lower end part 61 of the front frame 60 is fixed to the front end part 41 of the reinforcement member 40, and the lower end part 71 of the rear frame 70 is fixed to the rear end part 42 of the reinforcement member 40.

### (E) On Door Panel Member

A case the door panel member in the present invention is the inner panel 20 is exemplified in the embodiment illustrated in FIGS. 1 to 8 and FIG. 10, a case the door panel member is the inner panel 20 and the reinforcement member 40 is exemplified in the embodiment illustrated in FIG. 9, and a case the door panel member is the reinforcement member 40 is exemplified in the embodiment illustrated in FIG. 11, however, the door panel member in the present invention is not limited to them. The door panel member in the present invention may be the outer panel 30 for example, and may be a member other than those described above configuring a part of the door body part 10.

### (F) On First Joining Step

The door component manufactured by the first joining step in the manufacturing method related to the embodiment may be one where the lower end part 61 of the front frame 60 is joined to the front end part of the outer panel 30 and the lower end part 71 of the rear frame 70 is joined to the rear end part of the outer panel 30. In such a case, the door component includes the outer panel 30 as the door panel member, the front frame 60, the rear frame 70, and the temporarily fixing member 80.

### (G) On Temporarily Fixing Step

Although a case of temporarily fixing the upper end parts 62, 72 to each other by the bolt 81 and the nut 82 in the temporarily fixing step is exemplified in the embodiment, the present invention is not limited to it. For example, in the temporarily fixing step, the upper end parts 62, 72 may be temporarily fixed by a sandwiching member that sandwiches them.

Further, although the manufacturing method related to the embodiment includes the temporarily fixing step, it is possible to omit the temporarily fixing step.

### (H) On Heating Step

Although the heating step is the baking step (drying step) executed after the door component 101 is painted according to the embodiment, the present invention is not limited to it, and another step other than the drying step is also possible.

### (I) On Second Joining Step

Although the fixing member 80 for fixing the upper end part 62 (the other end part) of the front frame 60 and the upper end part 72 (the other end part) of the rear frame 70 to each other in the second joining step is the same as the temporarily fixing member 80 for temporarily fixing these upper end parts 62, 72 to each other in the temporarily fixing step according to the embodiment, the present invention is not limited to it. A method for fixing the upper end parts 62, 72 to each other in the second joining step may be different from the method for temporarily fixing these upper end parts 62, 72 to each other in the temporarily fixing step. Concretely, it is also possible that the upper end parts 62, 72 are temporarily fixed to each other by the bolt 81 and the nut 82 in the temporarily fixing step, and that the upper end parts 62, 72 are fixed to each other by welding, rivets, and the like in the second joining step.

This application claims the benefits of priority to Japanese Patent Application No. 2019-094289, filed May 20, 2019. The entire contents of the above application are herein incorporated by reference.

1. A method for manufacturing a vehicular side door, the vehicular side door comprising at least one door panel member and a sash part, the door panel member being configured of a first material having a first coefficient of linear expansion, the sash part being joined to at least one door panel member and being configured of a second material having a second coefficient of linear expansion that is different from the first coefficient of linear expansion, said method comprising:
joining each of one end part of a front frame configuring a front portion of the sash part in the vehicle longitudinal direction and one end part of a rear frame configuring a rear portion of the sash part in the vehicle longitudinal direction to at least one door panel member;
heating at least one door panel member, the front frame, and the rear frame; and
joining the other end part of the front frame and the other end part of the rear frame to each other.

2. The method for manufacturing a vehicular side door according to claim 1, wherein
modulus of elasticity of the second material is greater than modulus of elasticity of the first material, and
density of the second material is greater than density of the first material.

3. The method for manufacturing a vehicular side door according to claim 2, wherein
the first material is an aluminum alloy, and
the second material is steel.

4. The method for manufacturing a vehicular side door according to claim 3, wherein
the joining each of the one end part of the front frame and the one end part of the rear frame includes allowing an adhesive agent to be interposed between each of the one end part of the front frame and the one end part of the rear frame and at least one door panel member.

5. The method for manufacturing a vehicular side door according to claim 3, wherein
the second material is an aluminum-plated steel sheet.

6. The method for manufacturing a vehicular side door according to claim 1, wherein
at least one door panel member includes one panel out of an inner panel and an outer panel, and a reinforcement member disposed along the vehicle longitudinal direction for reinforcing the one panel, and
the joining each of the one end part of the front frame and the one end part of the rear frame comprises joining the reinforcement member to the one panel and joining each of the one end part of the front frame and the one end part of the rear frame to the reinforcement member so as to allow the reinforcement member to be interposed between each of the one end part of the front frame and the one end part of the rear frame and the one panel.

7. The method for manufacturing a vehicular side door according to claim 1, wherein
the joining each of the one end part of the front frame and the one end part of the rear frame comprises a temporarily fixing, and
the temporarily fixing includes overlaying the other end part of the front frame and the other end part of the rear frame on each other and temporarily fixing the other end part of the front frame and the other end part of the rear frame to each other so as to allow the other end part of the front frame and the other end part of the rear frame to be relatively displaced with each other in the heating.

8. The method for manufacturing a vehicular side door according to claim 7, wherein
the temporarily fixing comprises temporarily fixing the other end part of the front frame and the other end part of the rear frame to each other by a bolt with first fastening torque that allows the other end part of the front frame and the other end part of the rear frame to be relatively displaced with each other in the heating,
at least one of the other end part of the front frame and the other end part of the rear frame includes a bolt insertion hole to which the bolt is inserted, and
the bolt insertion hole has a dimension that allows the other end part of the front frame and the other end part of the rear frame to be relatively displaced with each other in the heating.

9. The method for manufacturing a vehicular side door according to claim 8, wherein
the bolt insertion hole is an elongated hole whose dimension in a specific direction is greater than a dimension in a direction orthogonal to the specific direction.

10. The method for manufacturing a vehicular side door according to claim 9, wherein
the dimension in the specific direction has a size in the vehicle longitudinal direction of the bolt insertion hole, and
the dimension in a direction orthogonal to the specific direction has a size in the vehicle vertical direction of the bolt insertion hole.

11. The method for manufacturing a vehicular side door according to claim 8, wherein
the joining the other end part of the front frame and the other end part of the rear frame includes joining the other end part of the front frame and the other end part of the rear frame to each other by the bolt with second fastening torque that is greater than the first fastening torque.

12. A door component, comprising:
at least one door panel member configured of a first material having a first coefficient of linear expansion; and
a sash part joined to at least one door panel member and configured of a second material having a second coefficient of linear expansion that is different from the first coefficient of linear expansion, wherein
the sash part includes a front frame configuring a front portion in the vehicle longitudinal direction and a rear frame configuring a rear portion in the vehicle longitudinal direction,
each of one end part of the front frame and one end part of the rear frame includes a joint part that is joined to at least one door panel member, and
at least one of the front frame and the rear frame includes a temporarily fixing part for temporarily fixing the other end part of the front frame and the other end part of the rear frame to each other so as to allow the other end part of the front frame and the other end part of the rear frame to be relatively displaced with each other.

13. The door component according to claim 12, wherein
modulus of elasticity of the second material is greater than modulus of elasticity of the first material, and
density of the second material is greater than density of the first material.

14. The door component according to claim 13, wherein
the first material is an aluminum alloy, and
the second material is steel.

15. The door component according to claim 12, wherein
at least one door panel member includes one panel out of an inner panel and an outer panel, and a reinforcement member disposed along the vehicle longitudinal direction for reinforcing the one panel,
the reinforcement member is joined to the one panel, and
each of the one end part of the front frame and the one end part of the rear frame is joined to at least one of the one panel and the reinforcement member.

16. The door component according to claim 12, wherein
at least one of the other end part of the front frame and the other end part of the rear frame includes a bolt insertion hole to which a bolt is inserted, the bolt being for temporarily fixing the other end parts to each other, and
the bolt insertion hole has a dimension that allows the other end part of the front frame and the other end part of the rear frame to be relatively displaced with each other.

17. The door component according to claim 16, wherein
the bolt insertion hole is an elongated hole whose dimension in a specific direction is greater than a dimension in a direction orthogonal to the specific direction.

18. The door component according to claim 17, wherein
the dimension in the specific direction has a size in the vehicle longitudinal direction of the bolt insertion hole, and
the dimension in a direction orthogonal to the specific direction has a size in the vehicle vertical direction of the bolt insertion hole.

19. A side door, comprising:
at least one door panel member configured of a first material having a first coefficient of linear expansion; and
a sash part joined to at least one door panel member and configured of a second material having a second coefficient of linear expansion that is different from the first coefficient of linear expansion, wherein
the sash part includes a front frame configuring a front portion in the vehicle longitudinal direction and a rear frame configuring a rear portion in the vehicle longitudinal direction,
each of one end part of the front frame and one end part of the rear frame includes a first joint part that is joined to at least one door panel member, and
at least one of the other end part of the front frame and the other end part of the rear frame includes a second joint part where a temporarily fixed state is made to be a joined state, the temporarily fixed state allowing the other end part of the front frame and the other end part of the rear frame to be relatively displaced with each other, the other end part of the front frame and the other end part of the rear frame being joined to each other in the joined state.

20. The side door according to claim 19, wherein
the second joint part includes a bolt insertion hole to which a bolt is inserted, the bolt being for joining the other end part of the front frame and the other end part of the rear frame to each other, and
the bolt insertion hole is an elongated hole whose dimension in a specific direction is greater than a dimension in a direction orthogonal to the specific direction.
